(19) United States
(12) Patent Application Publication
(10) Pub. No.: US 2008/0301996 A1
(43) Pub. Date: Dec. 11, 2008

(54) FISHING LURE AND BAIT ILLUMINATION ATTACHMENT

(76) Inventor: J. Stewart Gemmell, Delray Beach, FL (US)

Correspondence Address: BELL, BOYD & LLOYD, LLP, P.O. Box 1135, CHICAGO, IL, 60690, US

(21) Appl. No.: 12/124,837

(22) Filed: May 21, 2008

Related U.S. Application Data
(60) Provisional application No. 60/942,881, filed on Jun. 8, 2007.

(51) Int. Cl. A01K 91/06

(52) U.S. Cl. 43/17.5; 43/42.49

(57) ABSTRACT

A fishing lure illumination attachment is configured to releasably secure a light source and be releasably secured to a fishing line to illuminate a lure or bait.

### PRIORITY CLAIM

This application is a non-provisional application of, claims priority to and the benefit of U.S. Provisional Patent Application Ser. No. 60/942,881 filed on Jun. 8, 2007, the entire contents of which are incorporated herein by reference.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Fishermen use many different types of lures and bait to attract and catch fish. Certain fishermen use solid lures to catch fish. Certain fishermen use lures made of flexible material to catch fish. These flexible lures typically have a head and a tail or skirt. The head is typically tubular with a closed front end and an open back end. The skirt typically extends from the open back end. The head is typically hollow. A hook (attached to a line) is typically positioned under or inside the skirt to conceal the hook. Some fisherman place bait such as dead squid, fish and octopi in the cavity of the head to attract fish.

Certain fisherman use lighting devices in conjunction with lures to attract fish. Under low light and poor visibility conditions, some fish are attracted to phosphorescent lures. Certain lures include electrical light sources. These electrical light sources are expensive and are vulnerable to short circuiting in the water. Additionally, electrical light sources are bulky and permanent fixtures in a lure. That is, the electrical light source is not removable from the lure and is not replaceable. The electrical light source also has a limited life span.

Lures for certain types of fishing, such as swordfish fishing, are costly. Therefore, it is desirable to be able to transform a non-illuminated lure into a luminated lure and vice versa. It is also desirable to be able to illuminate the bait so that fish may see it better.

Therefore, there is a need for new lures and bait illumination for attracting fish.

### SUMMARY

The present disclosure relates to a fishing lure and bait illumination attachment that is configured to releasably secure a light source and be releasably secured to a fishing line to illuminate a fishing lure or fishing bait. In different embodiments, the fishing lure illumination attachment may be placed inside the lure or bait or adjacent to or near the lure or bait.

More specifically, in one embodiment, the fishing lure illumination attachment is in the form of an insert or a plug configured to be inserted into a hollow head of a flexible fishing lure. The fishing lure illumination attachment may be any suitable shape that fits at least partially in the cavity of the lure. The fishing lure illumination attachment includes a body having a first end and a second end. In one embodiment, the second end includes at least one opening for a light receiver or receptor that extends from the opening into the body, chambers or openings. These receivers are configured to releasably secure a self-illuminating light or light stick. These light receivers may be any suitable shape and size. In one embodiment, the light receivers are each cylindrical chambers extending into the body of the fishing lure illumination attachment. In one embodiment, the opening of each chamber is located at the second end of the body. In one embodiment, the light receivers are the appropriate size and shape to hold a chemiluminescent light stick. The chemiluminescent light stick or glow stick emits light as a result of a chemical reaction inside the light stick. The body of the fishing lure illumination attachment defines a fishing line channel configured to receive and hold fishing line or leader line to attach the fishing lure illumination attachment on the fishing line or leader line. Hooks are secured to the fishing line by a metal crimp or a knot. In one embodiment, the fishing lure illumination attachment defines a crimp or a knot receptor to enable the crimp or knot to rest against the fishing lure illumination attachment or to be received at least partially in the fishing lure illumination attachment.

In one embodiment, the fishing lure includes a semi-enclosed hollow head or hollow cavity formed by a plurality of walls and a skirt extending from the hollow head. In practice, a user causes at least one light to emit light and securely places each light into a respective light receiver. In one embodiment, the user places the fishing lure illumination attachment into the hollow cavity of the lure and threads a fishing line through the lure and the fishing lure illumination attachment. The user secures a hook to the fishing line using a knot or a crimp. The crimp or knot receptor at least partially receives the crimp or knot used to secure the hook to the fishing line.

In another embodiment, the fishing lure illumination attachment is configured to be inserted into bait. In one such embodiment, the fishing lure illumination attachment includes a body including a first end and a second end.

In one embodiment, the fishing lure illumination attachment is configured to fit into the head of squid bait. For example, the first end is in the shape of a mantle tip of a squid and is configured to be inserted into the mantle tip of the dead squid. In one embodiment, the fishing lure illumination attachment includes at least one light receiver extending into the body of the fishing lure illumination attachment from the second end. In one embodiment, the light receiver is configured to receive a chemiluminescent light stick. In one embodiment, the body defines a fishing line channel and at least one rigging hole configured to receive rigging to secure the fishing lure illumination attachment to the bait. It should be appreciated that the fishing lure illumination attachment may include any suitable number of rigging holes. A user may use any suitable securing device to secure the fishing lure illumination attachment to the bait via the rigging hole(s). Prior to using the fishing lure illumination attachment, the user illuminates a light and attaches the light to the fishing lure illumination attachment. The user places the fishing lure illumination attachment inside the bait and threads a fishing line through the bait and the fishing lure illumination attachment. The user secures a hook to the fishing line using a knot or a crimp. A crimp or knot receptor receives a portion of the crimp or knot used to secure the hook to the lead line. The user may use additional line or rigging floss to secure the bait to the fishing lure illumination attachment using the rigging holes.

In another embodiment, the fishing lure illumination attachment is configured to fit adjacent to or behind or in front of a lure or bait. Some lure heads and bait are solid or substantially solid. In one such embodiment, the fishing lure illumination attachment is configured to have fishing line threaded through the fishing line channel and receive a crimp or a knot such that one end of the fishing lure illumination attachment is adjacent to the crimp or the knot and the other end of the fishing lure illumination attachment is adjacent to the lure. In one embodiment, the lure and the fishing lure illumination attachment are slidably connected to the fishing line such that when a fish strikes the lure, the lure and the fishing lure illumination attachment slide up the fishing line away from the hook.

More specifically, in one embodiment, the fishing lure illumination attachment includes a body including a first end and a second end. In one embodiment, the second end includes at least one opening extended into the body defining at least one light receiver. The second end of the body defines a crimp and knot. In practice, the user threads the fishing line through the lure and the fishing lure illumination attachment and places the fishing lure illumination attachment behind and/or adjacent to the lure. The user then attaches the hook to the fishing line underneath the fishing lure illumination attachment and secures the fishing line with a crimp. The fishing lure illumination attachment rests between the lure and the crimp.

It should be appreciated that the fishing lure illumination attachment may be configured to receive any suitable number of lights or light sticks. It should also be appreciated that the light source may be any suitable size and shape and may be but is not limited to a chemiluminescent light stick or a light-emitting diode (LED).

The fishing lure illumination attachment may be any suitable shape, including but not limited to cylindrical, bullet shaped, spherical, tubular, rectangular, a cube, round, rectangular, square, oval, or shaped to fit inside any suitable cavity of lure or bait or be positioned behind, in front of or adjacently to the lure or bait.

It should be appreciated that the fishing lure illumination attachment may be attached to a lure, bait or line in any suitable manner. In one embodiment, the fishing lure illumination attachment includes a fishing line channel to be threaded to the line. In different embodiments, the fishing line channel includes a fishing line installation slit or opening or a leader line installation slit or opening that includes an opening extending from the fishing line channel to the exterior of the body of the fishing lure illumination attachment such that the fishing lure illumination attachment may be attached to the fishing line or leader line easily. In another embodiment, the fishing lure illumination attachment includes a securing device to attach the fishing lure illumination attachment to the line. For example, the body of the fishing lure illumination attachment includes a securing device which is a loop that is configured to secure the fishing lure illumination attachment to the line. In another example, the body of the fishing lure illumination attachment includes a securing device that snaps onto the line. In another embodiment, the fishing lure illumination attachment is configured to be tied to the line but not threaded through the body. In another embodiment, the fishing illumination attachment includes a securing member to be attached directly to the lure or bait without being attached to the line.

Additional features and advantages are described herein, and will be apparent from, the following Detailed Description and the figures.

### BRIEF DESCRIPTION OF THE FIGURES

FIG. 1 is a side cross-sectional view of one embodiment of the fishing lure illumination attachment configured to fit inside a flexible, hollow fishing lure and configured to receive a plurality of lights.

FIG. 2A is a rear view of one embodiment of the fishing lure illumination attachment of FIG. 1 that is configured to receive a plurality of lights.

FIG. 2B is a rear view of one embodiment of the fishing lure illumination attachment of FIG. 1 that is configured to receive a plurality of lights which includes a fishing line installation slit.

FIG. 3 is a side cross-sectional view of one embodiment of the fishing lure illumination attachment of FIG. 1 inside a flexible, hollow fishing lure.

FIG. 4 is a side cross-sectional view of one embodiment of the fishing lure illumination attachment configured to fit inside bait and configured to receive a plurality of lights.

FIG. 5A is a rear view of one embodiment of the fishing lure illumination attachment of FIG. 4 that is configured to receive a plurality of lights.

FIG. 5B is a rear view of one embodiment of the fishing lure illumination attachment of FIG. 4 that is configured to receive a plurality of lights which includes a fishing line installation slit.

FIG. 6 is a side cross-sectional view of one embodiment of the fishing lure illumination attachment of FIG. 4 inside squid bait.

FIG. 7 is a side cross-sectional view of one embodiment of the fishing lure illumination attachment configured to receive a plurality of lights and to be secured on a line between a lure and a hook.

FIG. 8A is a rear view of one embodiment of the fishing lure illumination attachment of FIG. 7 configured to be secured to the fishing line in-between the lure and the hook.

FIG. 8B is a rear view of one embodiment of the fishing lure illumination attachment of FIG. 7 configured to be secured to the fishing line in-between the lure and the hook which includes a fishing line installation slit.

FIG. 9 is a side cross-sectional view of one embodiment of the fishing lure illumination attachment of FIG. 7 that is configured to receive a plurality of lights.

### DETAILED DESCRIPTION

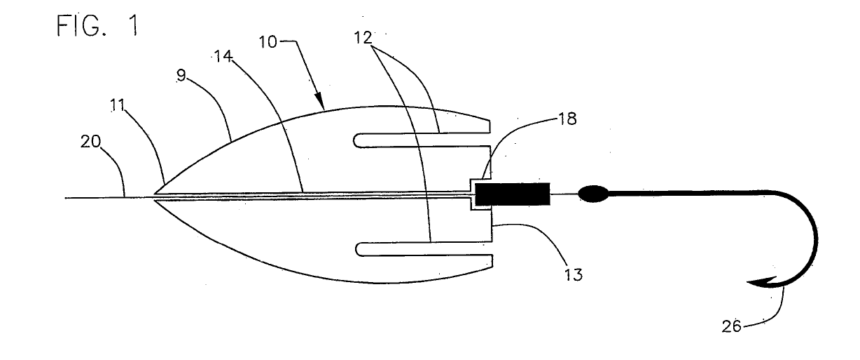

As illustrated in FIGS. 1 to 3, in one embodiment, the fishing lure illumination attachment 10 is configured to fit inside a hollow cavity of a flexible lure.

More specifically, as illustrated in FIG. 1, the fishing lure illumination attachment generally indicated by numeral 10 includes a body 9 having a first end 11 and a second end 13. In the illustrated embodiment, the body of the fishing lure illumination attachment is bullet shaped such that the first end is pointed and the second end is cylindrical. The body 9 defines a plurality of light receivers 12 each configured to receive, hold and secure any suitable size light or light stick. In the illustrated embodiment, each light receiver has an open end at the rear or second end 13 of the body. It should be appreciated that the light receivers may include open ends located at any suitable part of the body. In the illustrated embodiment, the light receivers are cylindrical chambers that are the appropriate size to hold a chemiluminescent light stick. The body 9 defines a fishing line channel or a leader line channel 14. In one embodiment, the fishing line channel is a cylindrical, hollow opening that is configured to receive fishing line or leader line to attach the fishing lure illumination attachment to the fishing line or leader line. As illustrated in FIG. 1, in one embodiment, the fishing line 20 extends through or is laid into the fishing line channel and is connected to a hook 26.

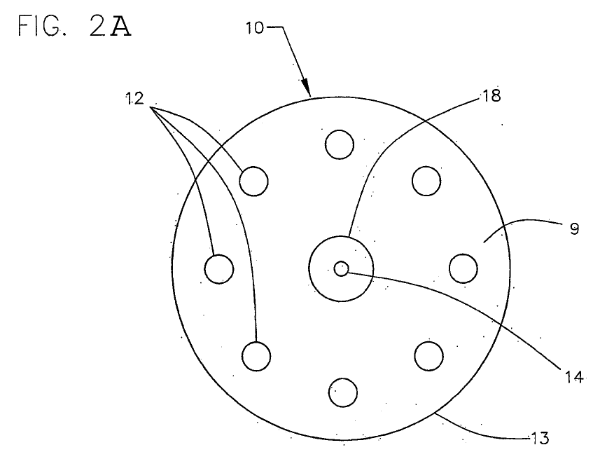

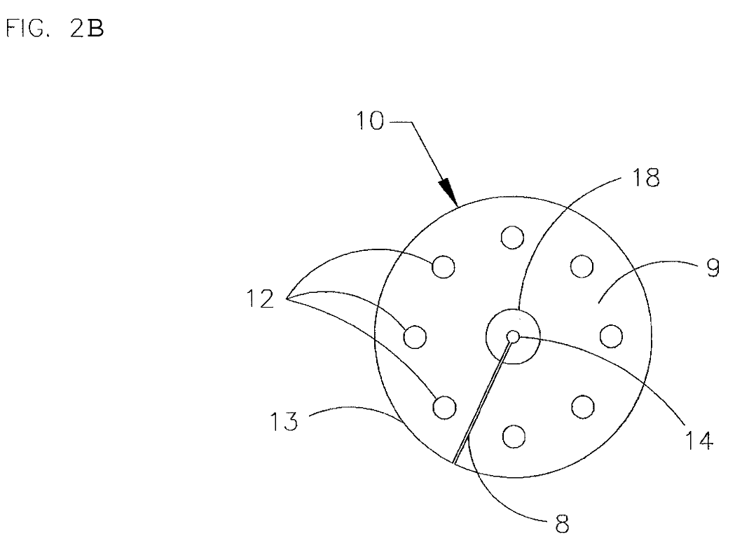

As illustrated in FIG. 2A, the body 9 of the fishing lure illumination attachment defines a fishing line channel 14 and a plurality of light receivers 12. The fishing lure illumination attachment includes a plurality of light receivers 12 and a user, such as a fisherman, may elect to use less than all of the light receivers.

As illustrated in FIG. 2B, the body of the fishing lure illumination attachment defines a fishing line installation slit 8 that enables a user to insert the fishing line or leader line into the fishing line channel.

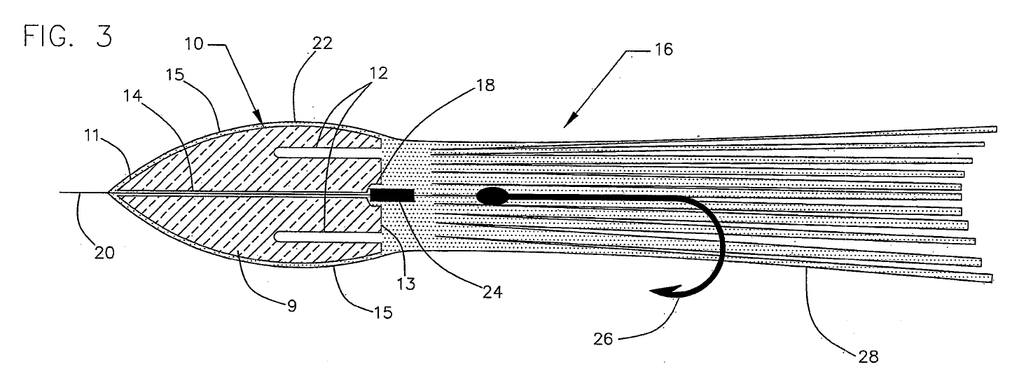

As illustrated in FIG. 3, the fishing lure illumination attachment 10 is configured to be inserted into a hollow chamber of a flexible fishing lure 16. In one embodiment, the flexible fishing lure includes a semi-enclosed hollow head 22 which defines a cavity formed by a wall 15. The flexible fishing lure includes a skirt 28 that extends from the hollow head 22. In one embodiment, the fishing lure resembles bait, such as a squid or an octopus. In one such embodiment, the user threads, lays or otherwise attaches the fishing lure to the fishing line. In one embodiment, the user places the fishing lure illumination attachment underneath the skirt and threads the fishing lure illumination attachment with the fishing line by running or laying the fishing line through the fishing line channel. The user then places the fishing lure illumination attachment into the hollow head 22. The user threads or attaches a hook and uses a knot or a crimp 24 to secure the hook to the fishing line. In one embodiment, the knot or crimp extends at least partially into a crimp or knot receptor 18. It should be appreciated that the fishing lure illumination attachment may be of any size and shape to fit inside any part of any lure.

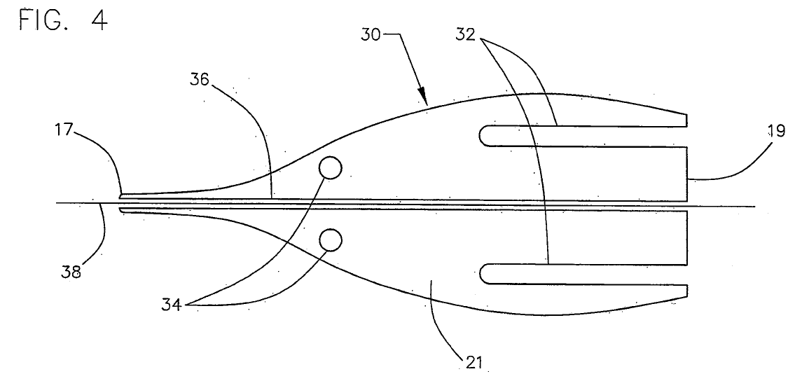

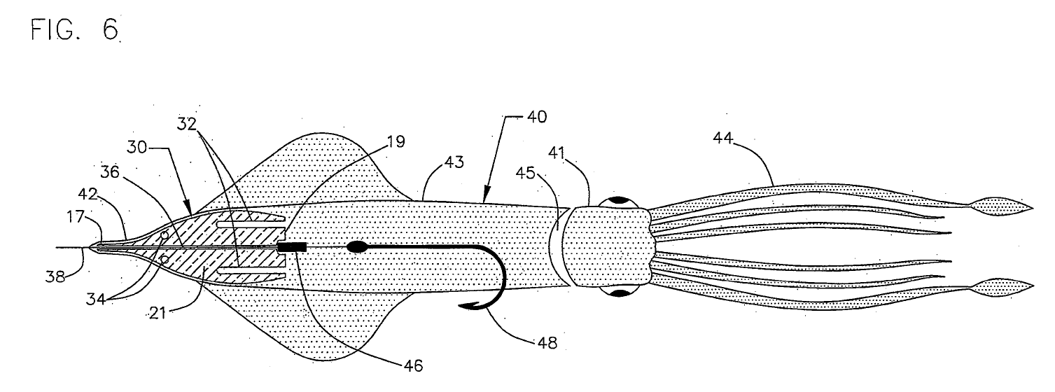

FIGS. 4, 5A, 5B and 6 illustrate one embodiment of a fishing lure illumination attachment configured to be inserted into bait, such as dead squid. As illustrated in FIGS. 4, 5A, 5B and 6, in one embodiment, the fishing lure illumination attachment, generally indicated by numeral 30, includes a body 21 having a first end 17 and a second end 19. In one embodiment, the first end is in the shape of a mantle tip of a squid and is configured to be inserted into the mantle tip of a squid. In one embodiment, the fishing lure illumination attachment includes a plurality of light receivers 32 defined by the body of the fishing lure illumination attachment and which each include open ends at the second end. It should be appreciated that the light receivers may include open ends located at any suitable part of the body. In the illustrated embodiment, these light receivers are configured to receive a chemiluminescent light stick but can be configured to use any light-emitting device. In one embodiment, the body of the fishing lure illumination attachment defines a fishing line channel 36. In one embodiment, the fishing lure illumination attachment defines a plurality of rigging holes 34 that a user may use to secure the fishing lure illumination attachment to the bait. The user may use any suitable securing device or means to secure the fishing lure illumination attachment to the bait. In one embodiment, the user threads or attaches the bait to the fishing lure illumination attachment using the rigging holes. In another embodiment, the user uses a pin to secure the bait to the fishing lure illumination attachment. In practice, a user places the fishing lure illumination attachment under the skirt or tentacles 44 and slides the fishing lure illumination attachment into the body 40 of the bait. In another embodiment, the body 40 of the bait includes a head portion 41 and a mantle portion 43 which includes a mantle tip 42. In one such embodiment, the body 40 of the bait includes an opening 45 between the head portion and the mantle portion. In one such embodiment, the user inserts the fishing lure illumination attachment through the opening 45 and slides the fishing lure illumination attachment into the mantle portion 43 of the bait. In one embodiment, the user slides the fishing lure illumination attachment up into the mantle tip 42 of the mantle portion 43 of the bait. The user attaches the fishing line 38 to the bait and to the fishing lure illumination attachment. In one embodiment, the user secures the hook 48 to the fishing line with a crimp 46 or a knot. In one embodiment, the user uses fishing line or rigging floss to secure the fishing lure illumination attachment to the bait using the rigging holes.

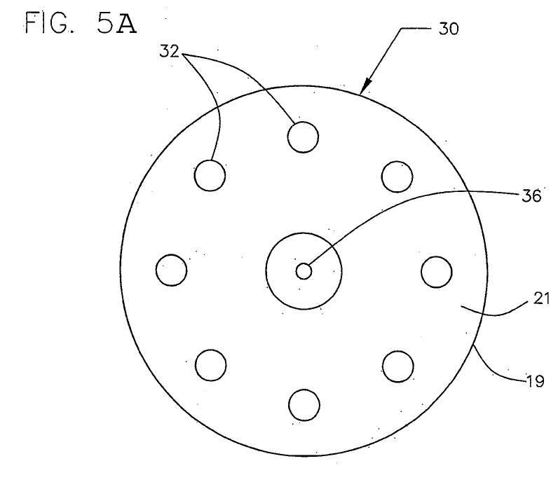

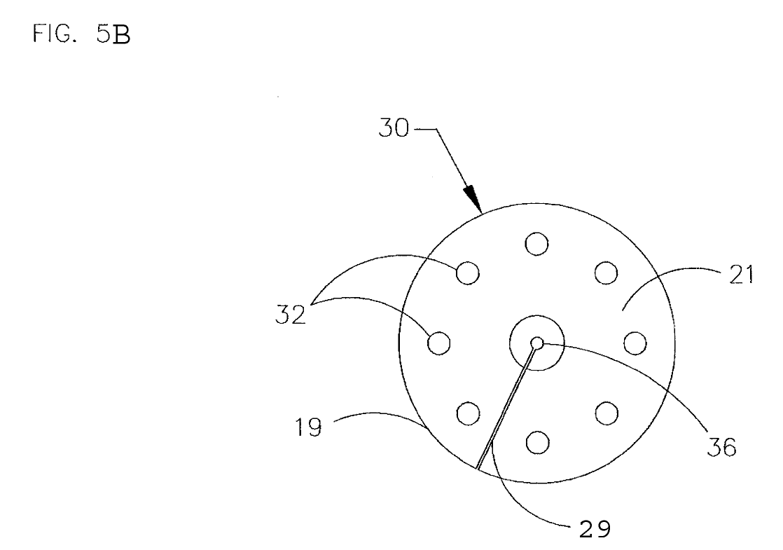

As illustrated in FIG. 5B, the body of the fishing lure illumination attachment defines a fishing line installation slit 29 that enables a user to insert the fishing line or leader line into the fishing line channel.

It should be appreciated that the fishing lure illumination attachment may be configured to be inserted into any suitable type of bait such as but not limited to squid, octopi, cuttlefish or fish.

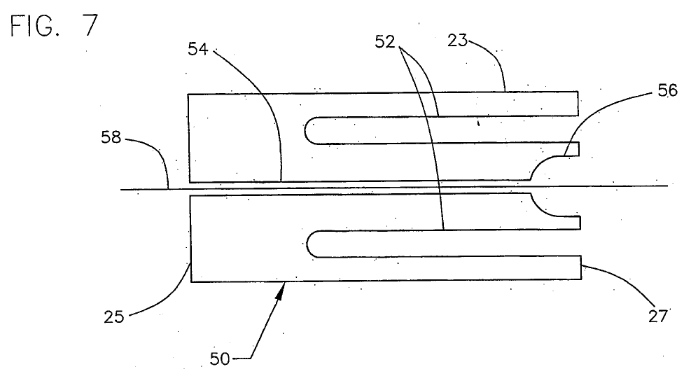

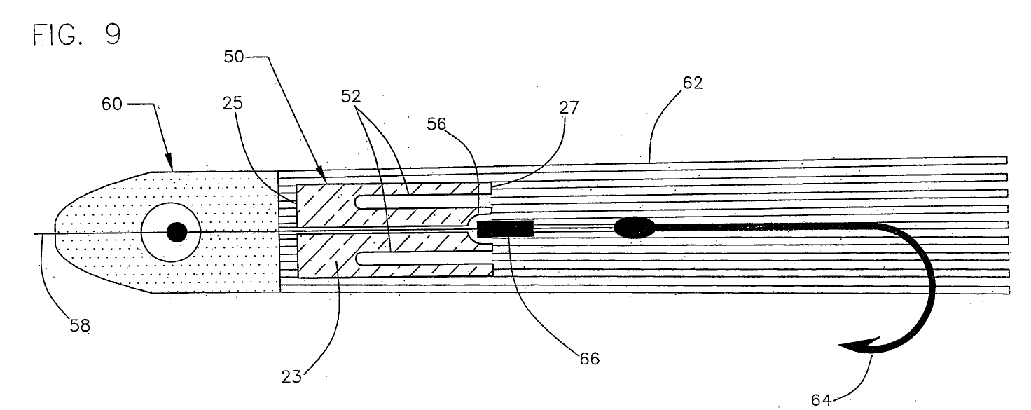

FIGS. 7, 8A, 8B and 9 illustrate an embodiment of the fishing lure illumination attachment which is configured to be secured on the fishing line between and adjacent to a lure and a hook. In one embodiment, the lure and the fishing lure illumination attachment are slidably connected to the fishing line such that when a fish strikes the lure, the lure and the fishing lure illumination attachment slide up the fishing line away from the hook.

As illustrated in FIGS. 7, 8A, 8B and 9, in one embodiment, the fishing lure illumination attachment, generally indicated by numeral 50, includes a body 23 having a first end 25 and a second end 27. In one embodiment, the body is cylindrical in shape. In one embodiment, the body defines a plurality of light receivers 52 extending from the first end or second end. In one embodiment, the body defines a fishing line channel 54 configured to receive and hold the fishing line. In one embodiment, the body defines a crimp and knot receptor 56. In practice, the user threads the fishing line 58 through the lure 60 or otherwise secures the fishing line to the lure, runs fishing line through the fishing line channel of the body or otherwise secures the fishing line to the fishing lure illumination attachment and places the fishing lure illumination attachment behind or in front of the lure. The user then attaches the hook 64 to the fishing line underneath the skirt and secures the fishing line with a crimp or knot 66 which rests against or in or at least partially in the crimp or knot receptor 56. In one embodiment, the fishing lure illumination attachment rests adjacently to the crimp and the lure. In one embodiment, the lure and the fishing lure illumination attachment are configured to move up the fishing line.

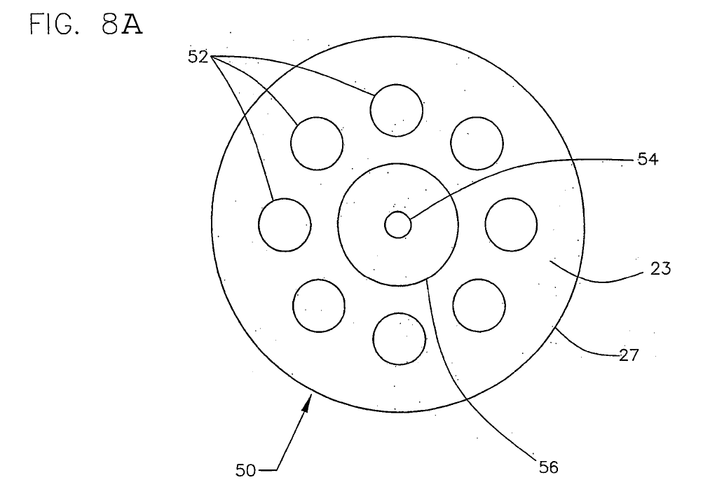

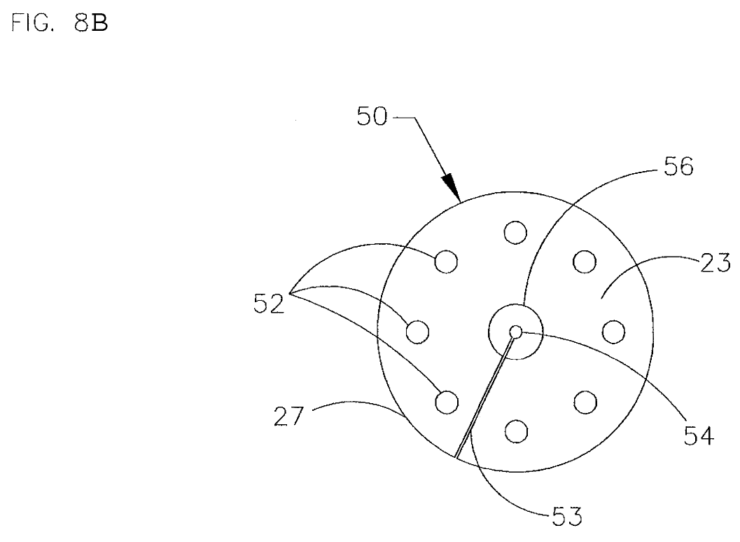

As illustrated in FIG. 8B, the body of the fishing lure illumination attachment defines a fishing line installation slit 53 that enables a user to insert the fishing line or leader line into the fishing line channel.

It should be appreciated that the fishing lure illumination attachment may be constructed of any suitable material. The material may be hard or soft. In one embodiment, the fishing lure illumination attachment is constructed of a clear or substantially clear plastic. In another embodiment, the fishing lure illumination attachment is constructed of polycarbonate. In another embodiment, the fishing lure illumination attachment is constructed of lexan. In another embodiment, the fishing lure illumination attachment is constructed of hard polyurethane or soft polyurethane. In another embodiment, the fishing lure illumination attachment is constructed of resin. In another embodiment, the fishing lure illumination attachment is constructed of acrylic.

It should be appreciated that the fishing lure illumination attachment may include any suitable number of light receivers extending from any suitable area of the body of the fishing lure illumination attachment. In one embodiment, all of the light receivers are the same size. In another embodiment, at least two of the light receivers are different sizes for receiving different types of lights. In one embodiment, light receiver accessories are configured to change the size of the light receivers such that the light receivers may hold different sizes of lights. For example, a light receiver accessory is an insert configured to make the light receiver narrower. In another embodiment, the light receiver accessory is an insert configured to make the light receiver shorter.

The light receivers may secure or hold the light in any suitable manner. In one embodiment, the light receivers are the correct size such that a light is secured into the light receiver when the user places the light in the light receiver. In another embodiment, the light receivers include one or a plurality of holding members configured to hold the light inside the light receiver. In one embodiment, the holding members are configured to snap or to hold the light in place. In another embodiment, the holding members are made of a contractible and expandable material to secure the light such that the material surrounds the light to secure the light. In another embodiment, the holding members of the light receivers are a latch, strap or other securing device to secure the light to the fishing lure illumination attachment.

It should be appreciated that the fishing lure illumination attachment may be used with any suitable lure or bait. In one embodiment, the fishing lure illumination attachment is configured to be inserted into the head of any hollow lure, such as a hollow replica of a squid, octopi or fish. In one embodiment, a portion or the entire lure is translucent. In another embodiment, the fishing lure illumination attachment is configured to be placed inside dead bait, such as squid, octopi, cuttlefish or fish. In another embodiment, the fishing lure illumination attachment is configured to be attached directly to or on a line in a suitable proximity to the hollow lure or bait. In another embodiment, the fishing lure illumination attachment is configured to be used with a solid lure or bait and to be attached directly to or on a line in a suitable proximity to the solid lure or bait.

The fishing lure illumination attachment may be used to attract any suitable type of fish. In one embodiment, the fishing lure illumination attachment is used with swordfish lures and swordfish bait. In other embodiments, the fishing lure illumination attachment is used to catch dolphin, marlin, sailfish, wahoo, grouper, shark, tuna, snapper, barracuda or any other suitable fish.

The fishing lure illumination attachment may be any suitable shape, including but not limited to cylindrical, cubical, bullet shaped, spherical, round, rectangular, square, oval, or shaped to fit into any suitable lure part or bait part.

It should be appreciated that the fishing line channel may be any suitable shape and size to receive any suitable type of fishing line or leader line. In an alternative embodiment, the fishing lure illumination attachment does not include a fishing line channel but includes an attachment such as a loop extending from the fishing lure illumination attachment to attach the fishing lure illumination attachment to the fishing line. In another alternative embodiment, the fishing lure illumination attachment does not include a fishing line channel and includes a strap or securing device that secures or snaps the fishing lure illumination attachment directly to the lure or bait without the use of line.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A fishing lure illumination attachment comprising:
a body having a first end and a second end, said body defining:
(a) at least one light receiver configured to receive a light source, said at least one light receiver extending from the second end to the first end; and
(b) at least one fishing line channel configured to receive a fishing line,
wherein said body is configured to be inserted into a hollow chamber of a fishing lure and attached to the fishing line.

2. The fishing lure illumination attachment of claim 1, wherein the body defines a fishing line installation slit.

3. The fishing lure illumination attachment of claim 1, wherein the body has a shape selected from the group consisting of a cylinder, a bullet, a sphere, and a cube.

4. The fishing lure illumination attachment of claim 1, wherein the body defines a crimp receptor.

5. The fishing lure illumination attachment of claim 1, wherein said at least one light receiver is cylindrical in shape.

6. The fishing lure illumination attachment of claim 1, wherein said at least one light receiver is configured to receive the light source in a form of a light stick.

7. A bait fishing lure illumination attachment, said fishing lure illumination attachment comprising:
a body having a first end and a second end, the first end configured in a form of a bait and the second end being substantially cylindrical, said body defining:
(a) a plurality of light receivers, wherein said light receivers extend from the second end towards the first end; and
(b) a fishing line channel.

8. The bait fishing lure illumination attachment of claim 7, wherein the body defines a fishing line installation slit.

9. The bait fishing lure illumination attachment of claim 7, wherein the body has a shape selected from the group consisting of a cylinder, a bullet, a sphere, and a cube.

10. The bait fishing lure illumination attachment of claim 7, wherein the body defines a crimp receptor in a center of the second end.

11. The bait fishing lure illumination attachment of claim 7, wherein said at least one light receiver is cylindrical in shape.

12. The bait fishing lure illumination attachment of claim 7, wherein said body defines a plurality of rigging holes configured to receive a securing device to secure the body to the bait.

13. The bait fishing lure illumination attachment of claim 7, wherein the body is configured to be inserted into the bait selected from one of the group consisting of squid, octopi, cuttlefish or fish.

14. A fishing lure illumination attachment comprising:
a body having a first end and a second end, said body defining:
(a) a plurality of light receivers;
(b) at least one crimp receptor; and
(c) at least one fishing line channel configured to receive a fishing line,
wherein the body is configured to be releasably secured to the fishing line adjacent to a fishing lure.

15. The fishing lure illumination attachment of claim 14, wherein the body defines a fishing line installation slit.

16. The fishing lure illumination attachment of claim 14, wherein the body has a shape selected from the group consisting of a cylinder, a bullet, a sphere, and a cube.

17. The fishing lure illumination attachment of claim 14, wherein said plurality of light receivers include at least two different sized light receivers.

18. The fishing lure illumination attachment of claim 14, wherein said plurality of light receivers are configured to receive different types of light sources.

19. The fishing lure illumination attachment of claim 14, wherein at least one of said plurality of light receivers is cylindrical in shape.

20. The fishing lure illumination attachment of claim 14, wherein the said plurality of light receivers are arranged a cylindrical shape.
